(19) United States
(12) Patent Application Publication
(10) Pub. No.: US 2012/0117286 A1
(43) Pub. Date: May 10, 2012

(54) Interface Devices And Systems Including The Same

(75) Inventors: Jae-Geun Yun, Hwaseong-si (KR); Jun-Hyung Um, Seoul (KR); Hyun-Uk Jung, Hwaseong-si (KR); Sung-Min Hong, Hwaseong-si (KR); Jung-Sik Lee, Seoul (KR); Hyun-Joon Kang, Hwaseong-si (KR); Ling Ling Liao, Yongin-si (KR); Woo-Cheol Kwon, Suwon-si (KR)

(73) Assignee: SAMSUNG ELECTRONICS CO., LTD., Suwon-si (KR)

(21) Appl. No.: 13/287,339

(22) Filed: Nov. 2, 2011

(30) Foreign Application Priority Data
Nov. 2, 2010 (KR) 10-2010-0108125

(51) Int. Cl. G06F 13/00

(52) U.S. Cl. 710/110

(57) ABSTRACT

An interface device includes a transaction management unit, a buffer unit and a selection circuit. The transaction management unit selectively splits a transaction of a master device into a first sub-transaction and at least one remaining sub-transaction based on a size of the transaction. The buffer unit stores the remaining sub-transaction. The selection circuit selects one of the first sub-transaction and an output of the buffer unit in response to a select control signal.

### CROSS-REFERENCE TO RELATED APPLICATION(S)

This application claims priority under 35 U.S.C. §119 to Korean Patent Application No. 10-2010-0108125, filed on Nov. 2, 2010, in the Korean Intellectual Property Office (KIPO), the entire contents of which are incorporated herein by reference.

### BACKGROUND

1. Technical Field

Example embodiments generally relate to data transmission. More particularly, example embodiments relate to an interface device and a system including the same.

2. Description of the Related Art

According to convergence which integrates computers, communications, etc., market demand is changing from existing application specific integrated circuit (ASIC) or application specific standard product (ASSP) to System-on-chip (SoC). In addition, miniaturization trends and high-performance requirements of information technology (IT) devices have been chief factors in development of SoC industries.

SoC is a technology-intensive semiconductor field, which includes various complex functions on one chip. Methods for interconnecting intelligent devices included in the chip are being implemented.

### SUMMARY

At least some example embodiments provide an interface device capable of reducing latency and overhead for connection of a master device and a slave device.

At least some example embodiments provide a system including the interface device.

According to at least some example embodiments, an interface device includes a transaction management unit, a buffer unit and a selection circuit. The transaction management unit selectively splits a transaction of a master device into a first sub-transaction and at least one remaining sub-transaction based on a size of the transaction. The buffer unit stores the at least one remaining sub-transaction. The selection circuit selects one of the first sub-transaction and an output of the buffer unit in response to a select control signal.

In at least some example embodiments, the interface device may further include a boundary check unit. The boundary check unit may receive the transaction and generate a check signal to the transaction management unit, the check signal indicating if the size of the transaction exceeds a reference value.

In at least some example embodiments, if the size of the transaction exceeds the reference value, the boundary check unit is configured to generate the check signal having a first logic level and the transaction management unit is configured to split the transaction into the first sub-transaction and at least one remaining sub-transaction.

In at least some example embodiments, if the size of the transaction is below the reference value, the boundary check unit is configured to generate the check signal having a second logic level and the transaction management unit is configured to generate the transaction to the selection circuit without splitting.

In at least some example embodiments, the size of the transaction may correspond to a size of an address that is included in the transaction.

In at least some example embodiments, the buffer unit may include a plurality of registers storing the at least one remaining sub-transaction. The buffer unit is configured to sequentially output the remaining at least one sub-transaction to the selection circuit.

In at least some example embodiments, the interface device may further include a merging unit. The merging unit may merge at least one remaining sub-transaction provided sequentially from the buffer unit to generate a merged sub-transaction to the selection circuit.

In at least some example embodiments, the transaction may be one of a write transaction and a read transaction.

In at least some example embodiments, the write transaction may include a write address and a write data when the transaction is the write transaction.

In at least some example embodiments, the read transaction may include a read address and a read data when the transaction is the read transaction.

In at least some example embodiments, the interface device may operate according to Advanced Extensible Interface (AXI) protocol.

According to at least some example embodiments, a system includes a plurality of master devices, a plurality of slave devices, an interconnect device and a slave interface device. The interconnect device connects the plurality of master devices and the plurality of slave devices. The slave interface device is between each of the slave devices and the interconnect device and the slave interface device is configured to process data that is transmitted between at least one of the master devices and one of the plurality of slave devices associated with the slave interface device. The slave interface device includes a transaction management unit, a buffer unit and a selection circuit. The transaction management unit selectively splits a transaction from one of the plurality of master devices into a first sub-transaction and at least one remaining sub-transaction based on a size of the transaction. The buffer unit stores the at least one remaining sub-transaction. The selection circuit selects one of the head sub-transaction and an output of the buffer unit in response to a select control signal provided from one of the plurality of slave devices.

In at least some example embodiments, the plurality of master devices and the plurality of slave devices may be installed on one chip.

In at least some example embodiments, the interconnect device may include an arbiter and a routing unit. The arbiter may generate an arbitration signal based on a transaction from each of the plurality of master devices. The routing unit may select one of the transactions based on the arbitration signal.

In at least some example embodiments, the arbiter may generate the arbitration signal with Round-Robin scheduling.

In at least some example embodiments, the arbiter may generate the arbitration signal based on a priority of the transaction.

In at least some example embodiments, the system may further include a master interface device. The master interface device is between each of the plurality of master devices and the interconnect device and the master interface device is configured to process data transmitted between at least one of the slave devices and one of the plurality of master devices associated with the master interface device.

In at least some example embodiments, the master interface device may include an arbiter configured to generate an arbitration signal, a buffer and a selection circuit. The buffer may store packets from at least one of the plurality of the slave devices. The selection circuit may select one of the packets stored in the buffer to provide to the corresponding master device based on the arbitration signal.

In at least some example embodiments, each of the slave devices may be a memory device.

At least another example embodiment discloses a system configured to perform a transaction. The system includes at least one master device configured to transmit a transaction, the transaction identifying an address of an at least one slave device to receive the transaction, a slave interface device associated with the at least one slave device, the slave interface device configured to receive the transaction and divide the transaction into a plurality of sub-transactions based on a size of the address, and the at least one slave device configured to receive the plurality of sub-transactions.

According to at least some example embodiments, a transaction is split based on the size of the transaction. Therefore, latency and overhead can be decreased.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a system according to at least some example embodiments.

FIG. 2 is a diagram illustrating the system of FIG. 1 performing a read transaction according to at least some example embodiments.

FIG. 3 is a diagram illustrating the system of FIG. 1 performing a write transaction according to at least some example embodiments.

FIG. 4 is a timing diagram illustrating the read transaction operation of FIG. 2.

FIG. 5 is a timing diagram illustrating the write transaction operation of FIG. 3.

FIG. 6 is a block diagram illustrating an example of an interconnect device in FIG. 1.

FIG. 7 is a block diagram illustrating an example of a slave interface device in FIG. 1.

FIG. 8 is a block diagram illustrating another example of the slave interface device in FIG. 1.

FIG. 9 is a diagram illustrating an operation of the slave interface of FIG. 7 or FIG. 8 according to at least some example embodiments.

FIG. 10 is a diagram illustrating an operation of the slave interface of FIG. 7 or FIG. 8 according to at least some example embodiments.

FIG. 11 is a block diagram illustrating an example of a master interface device in FIG. 1.

FIG. 12 is a diagram illustrating a structure of a packet in FIG. 11 according to at least some example embodiments.

FIGS. 13A, 13B, 13C and 13D are diagrams illustrating an example structure of the packet when a number of master devices and slave devices is 8, respectively.

### DETAILED DESCRIPTION OF EXAMPLE EMBODIMENTS

Various example embodiments will be described more fully hereinafter with reference to the accompanying drawings, in which some example embodiments are shown. Inventive concepts may, however, be embodied in many different forms and should not be construed as limited to the example embodiments set forth herein. Rather, these example embodiments are provided so that this disclosure will be thorough and complete, and will fully convey the scope of inventive concepts to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of inventive concepts. As used herein, the singular forms “a,” “an” and “the” are intended to include the plural forms as well, unless the context clearly indicates otherwise. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

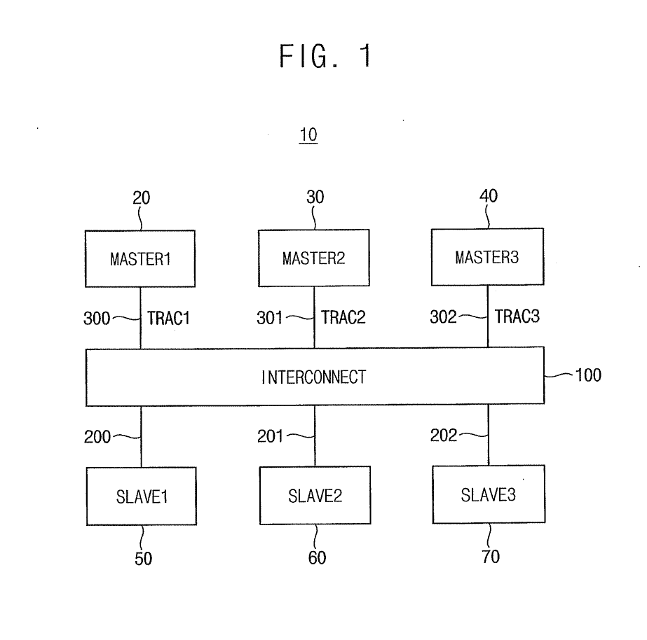

FIG. 1 is a block diagram illustrating a system according to at least some example embodiments.

Referring to FIG. 1, a system 10 includes a first master device 20 (MASTER1), a second master device 30 (MASTER2), a third master device 40 (MASTER3), a first slave device 50 (SLAVE1), a second slave device 60 (SLAVE2), a third slave device 70 (SLAVE3) and an interconnect device 100 (INTERCONNECT). Each of the master devices 20, 30, 40 is connected to the interconnect device 100 via master interface devices 300, 301, 302, respectively. Each of the slave devices 50, 60, 70 is connected to the interconnect device 100 via slave interface devices 200, 201, 202, respectively. Although the system 10 includes three master devices and three slave devices, the number of the master devices or the slave devices can be changed. Although the master interface devices 300, 301, 302 and the slave interface devices 200, 201, 202 are depicted as lines, the master interface devices 300, 301, 302 and the slave interface devices 200, 201, 202 may be other devices, not wires.

In at least some example embodiments, the slave devices 50, 60, 70 may be memory devices. In addition, the master devices 20, 30, 40 may be processors.

The first master device 20 may transmit a first transaction TRAC1 to the interconnect device 100 such that the first transaction TRAC1 is transmitted to at least one of the slave devices 50, 60, 70. The second master device 30 may transmit a second transaction TRAC2 to the interconnect device 100 such that the second transaction TRAC2 is transmitted to at least one of the slave devices 50, 60, 70. The third master device 40 may transmit a third transaction TRAC3 to the interconnect device 100 such that the third transaction TRAC3 is transmitted to at least one of the slave devices 50, 60, 70.

Each of the first to third transactions TRAC1, TRAC2, TRAC3 may be a request burst or a corresponding data burst from each of the first to third master devices 20, 30, 40, respectively. Each of the first to third transactions TRAC1, TRAC2, TRAC3 may include accesses to at least one of the first to third slave devices 50, 60, 70.

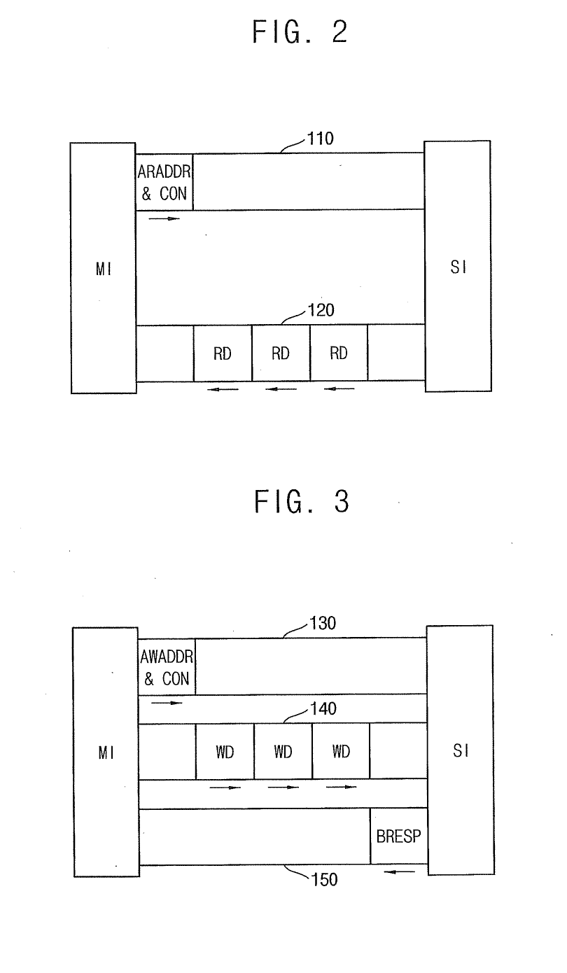

FIG. 2 is a diagram illustrating the system of FIG. 1 performing a read transaction.

Referring to FIG. 2, a master interface device MI transmits a read address ARADDR and a control signal CON to the slave interface device SI via a read address channel 110. In response to the read address ARADDR and the control signal CON, a slave interface device SI transmits read data RD to the master interface device MI via a read data channel 120. In other words, the system 10 of FIG. 1 may perform a read transaction via the read address channel 110 and the read data channel 120 in case of a read transaction.

Here, the master interface device MI may be one of the master interface devices 300, 301, 302 in FIG. 1. In addition, the slave interface device SI may be one of the slave interface devices 200, 201, 202 in FIG. 1.

FIG. 3 is a diagram illustrating the system of FIG. 1 performing a write transaction.

Referring FIG. 3, a master interface device MI transmits a write address AWADDR and a control signal CON to a slave interface device SI via a write address channel 130. The master interface device MI also transmits corresponding write data WD to the slave interface device SI via a write data channel 140. The slave interface device SI, which receives the write data WD, transmits a response signal BRESP to the master interface device MI via a write response channel 150. In other words, the system 10 of FIG. 1 may perform write transactions via the write address channel 130, the write data channel 140 and the write response channel 150 in case of write transaction.

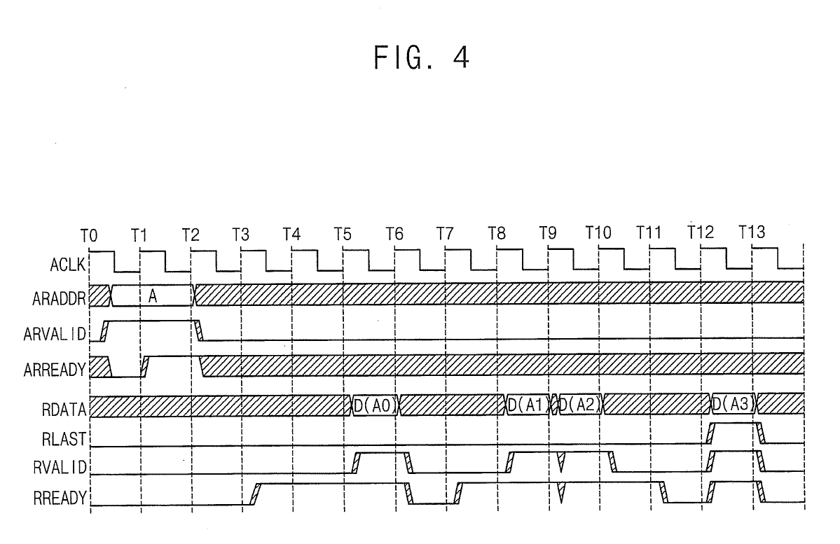

FIG. 4 is a timing diagram illustrating the read transaction operation of FIG. 2.

Referring to FIG. 4, a clock signal ACLK transitions to a high-level at times T0˜T13. In response to falling edge of the clock signal ACLK, the read address signal ARADDR is transmitted from the master interface device MI to the slave interface device SI. During the transmission of the read address signal ARADDR from the master interface device MI to the slave interface device SI, a read address validity signal ARVALID, which is transmitted from the master interface device MI to the slave interface device SI, is maintained at a high-level. The read address validity signal ARVALID indicates that the read address signal ARADDR is valid. During the transmission of the read address validity signal ARADDR from the master interface device MI to the slave interface device SI, a read address ready signal ARREADY is transmitted from the slave interface device SI to the master interface device MI. The read address ready signal ARREADY is maintained at a low-level during one period, and then transitions to the high-level during next period. The read address ready signal ARREADY indicates that the slave interface device SI is ready to receive the read address signal ARADDR.

A half-clock after the time T5, read data RDATA is transmitted from the slave interface device SI to the master interface device MI. In other words, read data D(A0) corresponding to an address A0, read data D(A1) corresponding to an address A1, read data D(A2) corresponding to an address A2, and read data D(A3) corresponding to an address A3 are transmitted from the slave interface device SI to the master interface device MI. During transmission of the read data D(A3) from the slave interface device SI to the master interface device MI, a last read data signal RLAST, which is transmitted from the slave interface device SI to the master interface device MI, is maintained at a high-level. The last read data signal RLAST indicates that the currently transmitted data is last. During the transmission of the read data D(A0), D(A1), D(A2), D(A3), a read data validity signal RVALID is maintained at a high-level. In addition, a read data ready signal RREADY is maintained at a high-level, at least during the transmission of the read data D(A0), D(A1), D(A2), D(A3).

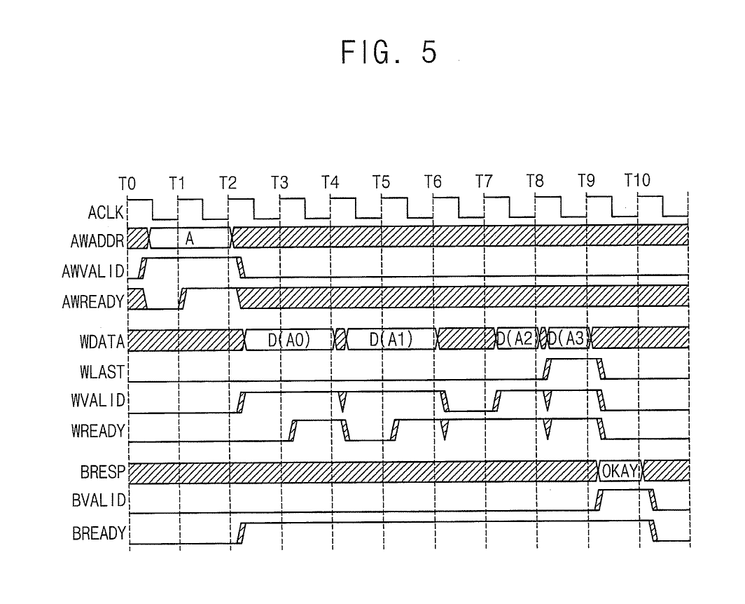

FIG. 5 is a timing diagram illustrating the write transaction operation of FIG. 3.

Referring to FIG. 5, a clock signal ACLK transitions to a high-level at times T0˜T13. In response to falling edge of the clock signal ACLK (a half-period after the time T0), the write address signal AWADDR is transmitted from the master interface device MI to the slave interface device SI. During the transmission of the write address signal AWADDR from the master interface device MI to the slave interface device SI, a write address validity signal AWVALID, which is transmitted from the master interface device MI to the slave interface device SI, is maintained at a high-level. The write address validity signal AWVALID indicates that the write address signal AWADDR is valid. During the transmission of the write address validity signal AWADDR from the master interface device MI to the slave interface device SI, a write address ready signal AWREADY is transmitted from the slave interface device SI to the master interface device MI. The write address ready signal AWREADY is maintained at a low-level during one period, and then transitions to high-level during next period. The write address ready signal AWREADY indicates that the slave interface device SI is ready to receive the write address signal AWADDR.

At time T2, write data WDATA is transmitted from the master interface device MI to the slave interface device SI. In other words, write data D(A0) corresponding to an address A0, write data D(A1) corresponding to an address A1, write data D(A2) corresponding to an address A2, and write data D(A3) corresponding to an address A3 are transmitted from the master interface device MI to the slave interface device SI. During transmission of the write data D(A3) from the master interface device MI to the slave interface device SI, a last write data signal WLAST, which is transmitted from the master interface device MI to the slave interface device SI, is maintained at a high-level. The last write data signal WLAST indicates that the currently transmitted data is last. During the transmission of the write data D(A0), D(A1), D(A2), D(A3), a write data validity signal WVALID is maintained at a high-level. In addition, a write data ready signal WREADY is maintained at a high-level, at least during the transmission of the write data D(A0), D(A1), D(A2), D(A3). The write date ready signal WREADY indicates that the slave interface device SI is ready to receive the write data signal WDATA.

In addition, after the transmission of the last write data D(A3), the write data response signal BRESP, which is transmitted from the slave interface device SI to the master interface device MI, shows ‘OKAY’ to indicate that the write data D(A0), D(A1), D(A2), DA(3) are surely transmitted. During the appearance of ‘OKAY’, a response validity signal BVALID is maintained at a high-level. During the transmission of the write data D(A0), D(A1), D(A2) and the appearance of ‘OKAY’, a response ready signal BREADY is maintained at a high-level.

The system 10 described with reference to FIGS. 1 to 5 supports burst transaction. One burst may include one to sixteen data transmissions. In other words, according to example embodiments, the number of data transmissions may be from one to sixteen in one burst.

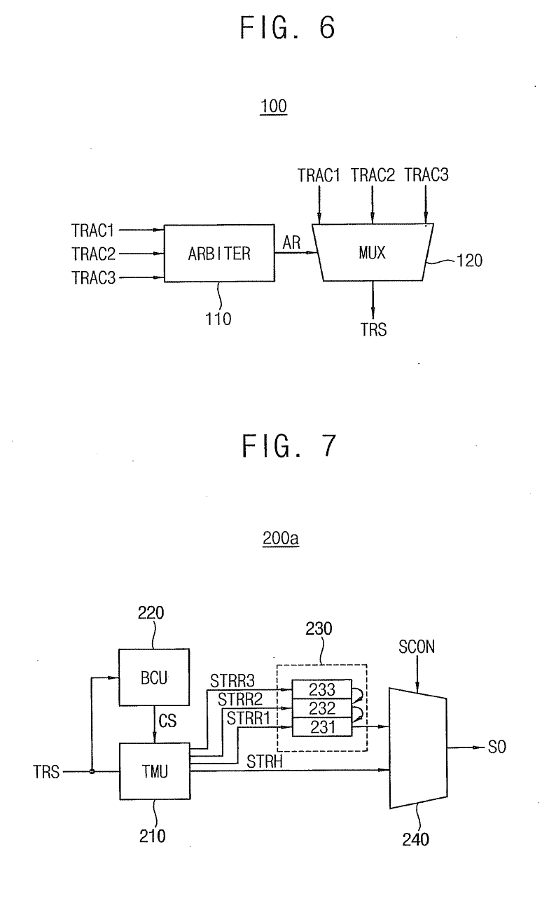

FIG. 6 is a block diagram illustrating an example of the interconnect device in FIG. 1.

Referring to FIG. 6, the interconnect device 100 includes an arbiter 110 and a routing unit 120 (MUX).

The arbiter 110 may receive first to third transactions TRAC1, TRAC2, TRAC3. The arbiter 110 may generate an arbitration signal AR based on the first to third transactions TRAC1, TRAC2, TRAC3. In response to the arbitration signal AR, the routing unit 120 may select one of the first to third transactions TRAC1, TRAC2, TRAC3 to provide a transaction TRS.

The arbiter 110 may receive the first to third transactions TRAC1, TRAC2, TRAC3, to generate the arbitration signal AR with Round Robin schedule. According to Round Robin schedule, the arbitration signal AR may be generated such that the first to third transactions TRAC1, TRAC2, TRAC3 are sequentially selected. In addition, the arbiter 110 may receive the first to third transactions TRAC1, TRAC2, TRAC3 to generate the arbitration signal AR with priority schedule. According to priority schedule, each of the transactions TRAC1, TRAC2, TRAC3 has corresponding priority. The arbitration signal AR may be generated so that the first to third transactions TRAC1, TRAC2, TRAC3 are selected based on the priorities. In some example embodiments, the arbiter 110 and the routing unit 120 may be placed with respect to each of the slave interface devices 200, 201, 202. The transaction TRS may be sequential transactions, when the arbiter 110 and the routing unit 120 are placed with respect to each of the slave interface devices 200, 201, 202 and the transactions TRAC1, TRAC2, TRAC3 require access to the same slave device.

Since the system 10 of FIG. 1 uses AXI protocol, the system may include multiple outstanding address function and data interleaving function.

By multiple outstanding address function, when information is provided through an address line and a data line of a bus (channel), each address of the data is transmitted only once through the address line in parallel with the data transmission. Therefore, unoccupied terms between addresses can be used. By data interleaving function, when a number of master devices transmit data to one slave device, data is mixed at slave device's end. Therefore, bandwidth can be used more efficiently.

FIG. 7 is a block diagram illustrating an example of the slave interface device in FIG. 1. The slave interface device 200a of FIG. 7 may be one of the slave interface devices 200, 201, 202 in FIG. 1.

Referring to FIG. 7, the slave interface device 200a may include a transaction management unit (TMU) 210, a boundary check unit (BCU) 220, a buffer unit 230 and a selection circuit 240.

The transaction management unit 210 receives a transaction TRS, and selectively splits the transaction TRS into a first sub-transaction STRH (first sub-transaction may also be referred to as a first sub-transaction) and at least one remaining sub-transaction STRR1, STRR2, STRR3 based on a size of the transaction TRS. The transaction TRS may be one of the first to third transactions TRAC1, TRAC2, TRAC3 selected by the arbiter 110 and the routing unit 120 in FIG. 6.

The boundary check unit 220 may receive the transaction TRS to check whether the size of the received transaction TRS exceeds a predetermined reference value. Then the boundary check unit 220 may provide a check signal CS for the transaction management unit 210. The check signal may indicate whether the size of the received transaction TRS exceeds the predetermined reference value. In accordance with the level of the check signal CS, the transaction management unit 210 may split the received transaction TRS into a first sub-transaction and at least one remaining sub-transactions, or may provide the received transaction TRS for the selection circuit 240 without splitting.

For example, when the size of the received transaction TRS exceeds the predetermined reference value, the check signal CS may have a first logic level (high-level). In response to the check signal CS having a high-level, the transaction management unit 210 splits the transaction TRS into the first sub-transaction STRH and at least one remaining sub-transactions STRR1, STRR2, STRR3. The number of the remaining sub-transactions STRR1, STRR2, STRR3 may be determined based on the predetermined reference value and the size of the transaction TRS.

For example, when the size of the received transaction TRS is below the predetermined reference value, the check signal CS may have a second logic level (low-level). In response to the check signal CS having a low-level, the transaction management unit 210 provides the transaction TRS for the selection circuit 240 without splitting. In this case, only the first sub-transaction STRH may be provided for the selection circuit 240.

When the size of the received transaction TRS exceeds the predetermined reference value, the at least one remaining sub-transactions are stored in the buffer unit 230. The buffer unit 230 includes a plurality of registers 231, 232, 233. Each of the registers 231, 232, 233 stores each of the remaining sub-transactions STRR1, STRR2, STRR3. The registers 231, 232, 233 are shift-queuing registers. Therefore, when the sub-transaction STRR1 is output from the register 231, the sub-transaction STRR2 stored in the register 232 is stored in the register 231. In other words, the buffer unit 230 may output the remaining sub-transactions STRR1, STRR2, STRR3 in sequence.

In response to a select control signal SCON from the slave device, the selection circuit 240 selects the first sub-transaction STRH or output of the buffer unit 230 to provide a result SO to the slave device. Since the first sub-transaction STRH and the remaining sub-transaction STRR1, STRR2, STRR3 are split from the transaction TRS, each of the first sub-transaction STRH and the remaining sub-transaction STRR1, STRR2, STRR3 may include a plurality of data transmissions, respectively. Therefore data interleaving can be performed by controlling the select control signal S CON. In detail, output timing of the data transmissions included in the first sub-transaction and the remaining sub-transaction can be controlled by controlling the logic level of the select control signal SCON, for data interleaving. The selection circuit 240 can be realized as a multiplexer, or other circuit devices functioning multiplexing.

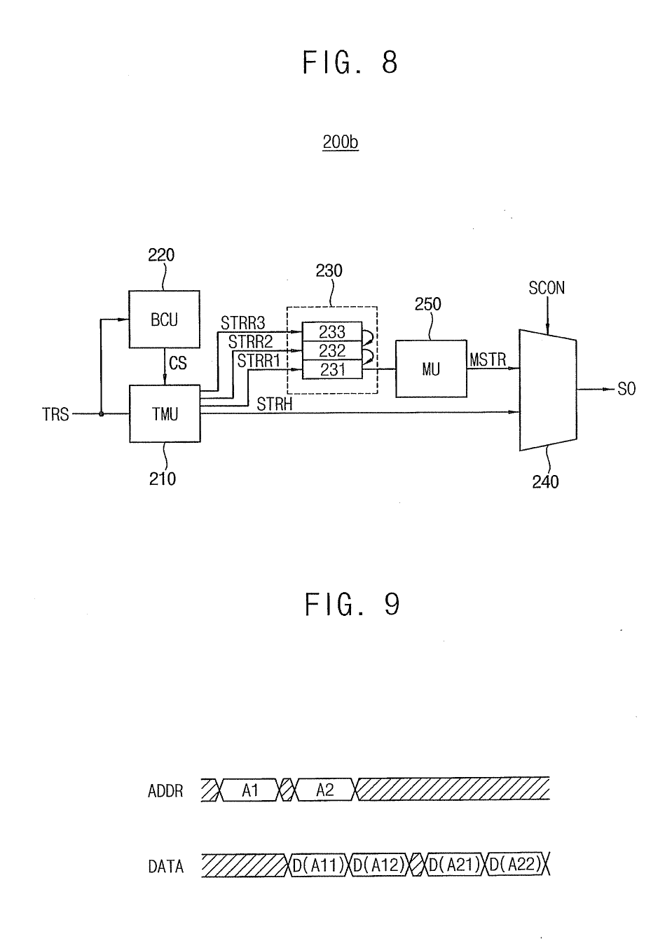

FIG. 8 is a block diagram illustrating another example of the slave interface device in FIG. 1.

Referring to FIG. 8, a slave interface device 200b may include the transaction management unit (TMU) 210, the boundary check unit (BCU) 220, the buffer unit 230, the selection circuit 240 and a merging unit (MU) 250.

The slave interface device 200b of FIG. 8 differs from the slave interface device 200a of FIG. 7 in that the slave interface device 200b of FIG. 8 further includes the merging unit 250.

The merging unit 250 merges the remaining sub-transactions STRR1, STRR2, STRR3, which are output of the buffer unit 230, to provide a merged sub-transaction MSTR for the selection circuit 240. When the number of the remaining sub-transactions STRR1, STRR2, STRR3 is increased, it may affect the system 10 as an overhead. Therefore, when the remaining sub-transactions STRR1, STRR2, STRR3 are merged into the merged sub-transaction MSTR, the overhead affecting the system 10 may be decreased. Since the remaining sub-transactions STRR1, STRR2, STRR3 are split from the transaction TRS, the remaining sub-transactions STRR1, STRR2, STRR3 may have consecutive addresses. Therefore, the remaining sub-transactions STRR1, STRR2, STRR3 can be merged into the merged sub-transaction MSTR. The number of the remaining sub-transactions STRR1, STRR2, STRR3 may be changed according to the size of the address of the received transaction TRS. Therefore, the merged sub-transaction MSTR may have a size corresponding to size of the address of the received transaction TRS.

In the description with reference to FIGS. 7 and 8, the transaction TRS may be directed to one of the slave devices 50, 60, 70. In other example embodiments, the transaction TRS may be directed to two or more of the slave devices 50, 60, 70. When the transaction TRS is directed to two or more of the slave devices 50, 60, 70, the sub-transactions directed to the other slave device may be provided to the corresponding slave interface to access the corresponding slave device.

FIG. 9 is a diagram illustrating an operation of the slave interface device of FIG. 7 or FIG. 8.

Referring to FIG. 9, data DATA D(A11), D(A12) corresponding to address A1 and data D(A21), D(A22) corresponding to address A2 are transmitted from the master interface device to the slave interface device. In the example embodiments of FIG. 9, the data D(A11), D(A12) and the data D(A21), D(A22) are transmitted from the master interface device to the slave interface device according to the order of transmitted addresses A1, A2. In other words, the salve interface devices 200a, 200b of FIGS. 7 and 8 do not perform data interleaving operation in FIG. 9. In addition, the address A2 for the data D(A21), D(A22) is transmitted before the transmission of the data D(A11), D(A12), which is corresponding to address A1, is completed. In other words, multiple outstanding function may be performed.

In FIG. 9, the address A1 and the data D(A11), D(A12) may be related to the slave device 50, and the address A2 and the data D(A21), D(A22) may be related to the slave device 60. In this case, when the slave interface device 200a in FIG. 7 is the slave interface device 200 in FIG. 1, the address A1 and the data D(A11), D(A12) may be provided for the slave device 50, and the address A2 and the data D(A21), D(A22) may be provided for the slave device 50.

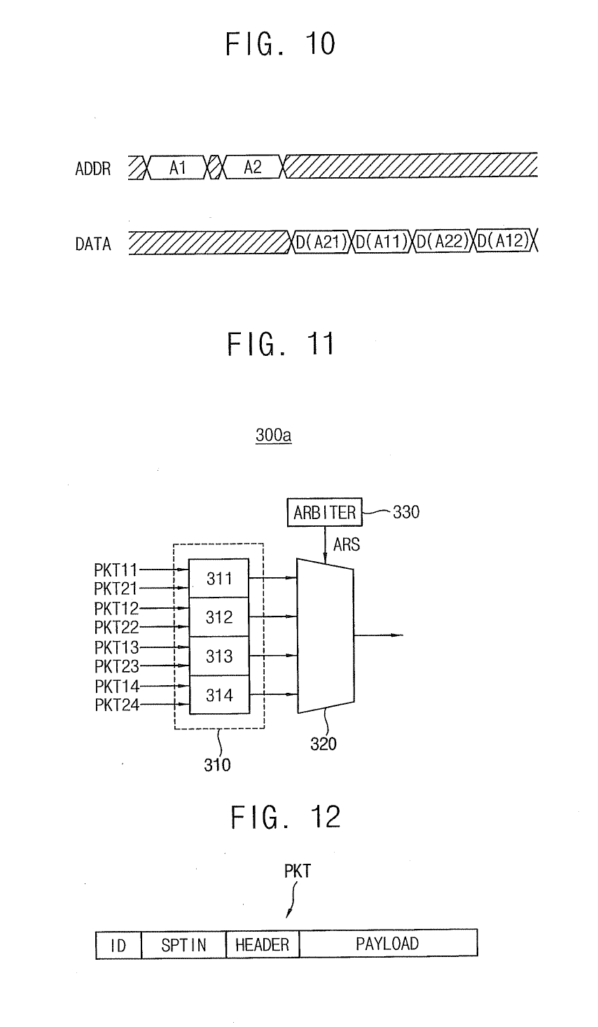

FIG. 10 is a diagram illustrating an operation of the slave interface device of FIG. 7 or FIG. 8.

Referring to FIG. 10, data D(A11), D(A12) corresponding to address A1 and data D(A21), D(A22) corresponding to address A2 are transmitted from the master interface device to the slave interface device. In the example embodiments of FIG. 10, the data D(A11), D(A12) and the data D(A21), D(A22) are transmitted from the master interface device to the slave interface device in following order: D(A21), D(A11), D(A22), D(A12). In other words, the salve interface devices 200a, 200b of FIGS. 7 and 8 perform data interleaving operation in FIG. 10.

FIG. 11 is a block diagram illustrating a master interface device in FIG. 1 according to at least some example embodiments.

A master interface device 300a may be one of the master interface devices 300, 301, 302 in FIG. 1.

Referring to FIG. 11, the master interface device 300a may include a buffer unit 310, a selection circuit 320 and an arbiter 330.

The buffer unit 310 includes a plurality of registers 311, 312, 313, 314. Each of the plurality of registers 311, 312, 313, 314 respectively stores packets, i.e., PKT11 and PKT21, PKT12 and PKT22, PKT13 and PKT23, PKT14 and PKT24. Here, the packets PKT11, PKT12, PKT13 and PKT14 may be provided by the slave device 50. In addition, the packets PKT21, PKT22, PKT23 and PKT24 may be provided by the slave device 60.

The arbiter 330 generates an arbitration signal ARS according to the state of one of the master interface devices 300, 301, 302 in FIG. 1. The selection circuit 320 selects one of the packets PKT11, PKT12, PKT13, PKT14 or one of the packets PKT21, PKT22, PKT23, PKT24 in response to the arbitration signal ARS to provide the selected packet for corresponding master device. Here, the packets PKT11, PKT12, PKT13, PKT14 or the packets PKT21, PKT22, PKT23, PKT24 may be the first sub-transaction or the remaining sub-transaction, which are split from the transactions provided by at least two of the slave devices 50, 60, 70 in FIG. 1.

FIG. 12 is a diagram illustrating a structure of the packet in FIG. 11.

Referring to FIG. 12, a packet PKT may include transmitter identification information ID, splitting information SPTIN, header information HEADER and payload PAYLOAD. Here, the header information HEADER may include information of type of the packet, data length, data size, data type, lock setting information. In addition, the payload PAYLOAD may include read data.

In other words, the sub-transaction may be composed of packets in the interface devices and systems according to example embodiments.

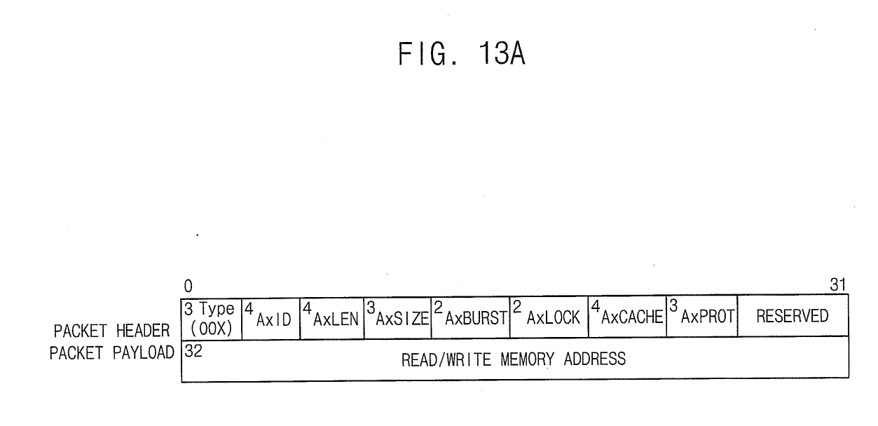

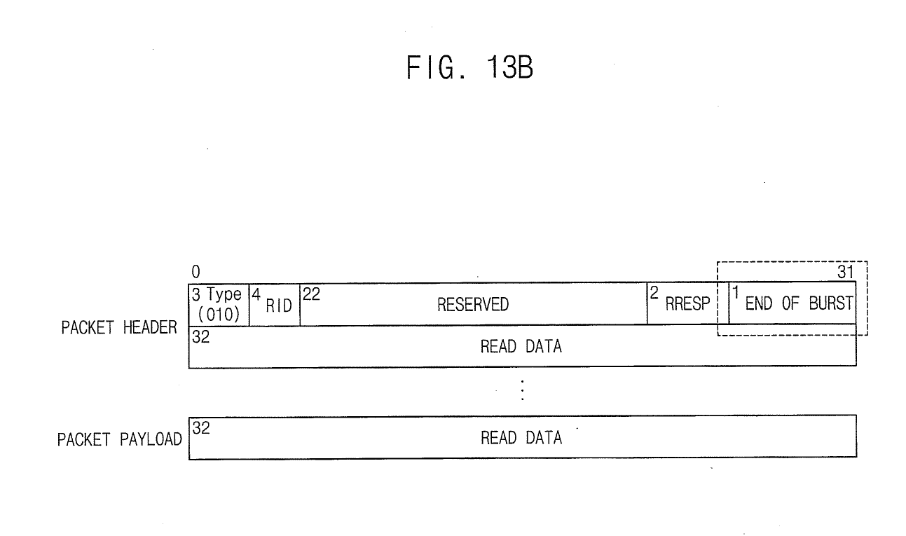

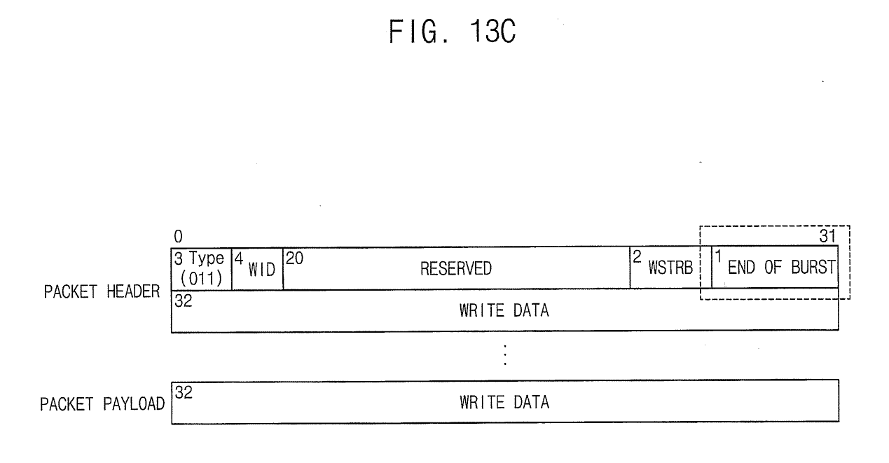

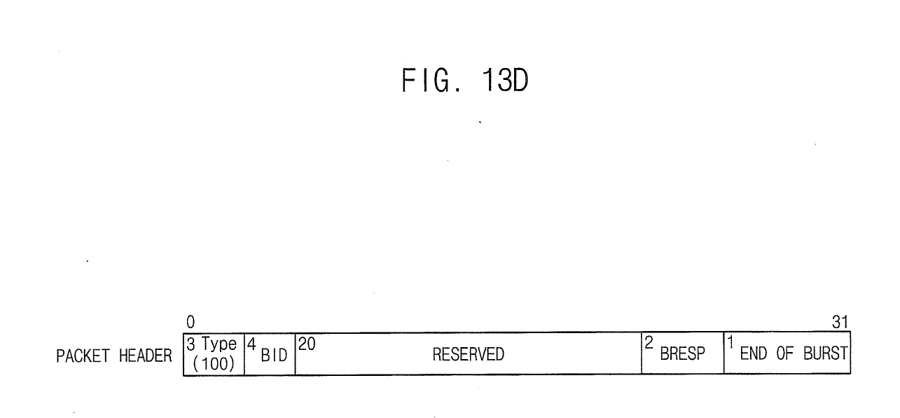

FIGS. 13A, 13B, 13C and 13D are diagrams illustrating a structure of the packet transmitted through the channel in FIGS. 2 and 3.

In FIGS. 13A, 13B, 13C and 13D, a structure of the packet will be described in case that the number of the master devices and the slave devices is 8, respectively.

FIG. 13A illustrates a structure of a read request packet and a write request packet which are transmitted through the read address channel 110 and the write address channel 130. The structures of the read request packet and the write request packet may have common structure.

Referring to FIG. 13A, the header includes information of packet type Type, transmitter ID AxID, data length AxLEN, data size AxSIZE, data type AxBURST, lock setting information AxLOCK, usage of cache memory AxCACHE, security level AxPROT. In addition, payload includes read memory address or write memory address. Here, the packet type (Type) indicates one of read request packet, write request packet, read packet, write packet and write response packet. The lock setting information AxLOCK indicates whether the lock is set in order that only particular AXI master or AXI slave receives the packets. The usage of cache memory AxCACHE indicates whether cache memory is capable of being used. The security level AxPROT indicates whether the packet should be protected, and indicates security level for protection of the packet. Here, the data length AxLEN indicates burst length, which means the number of the data transmission in one burst. The data length AxLEN may be one of 1 to 16 according to example embodiments. The data size AxSIZE indicates maximum data byte capable of being contained in each data transmission of the burst. The data size may be 1, 2, 4, 8, 16, 32, 64 or 128 bytes according to example embodiments.

FIG. 13B illustrates a structure of a read data packet transmitted through the read data channel 120 in FIG. 2.

Referring to FIG. 13B, a packet header includes information of packet type Type, identification of a slave device performing read operation in response to request of a master device (RID), information relating to whether the requested read packet is transmitted normally (RRESP), and information relating to whether the burst is the last burst (END OF BURST). Here, RRESP indicates whether the read request packet has been normally transmitted, whether a slave error has occurred, and whether an address error has occurred. A packet payload includes read data.

FIG. 13C illustrates a structure of a write data packet transmitted through the write data channel 140 in FIG. 3.

Referring to FIG. 13C, a packet header of the write data packet includes information of packet type (Type), identification of a slave device which is objective of writing (WID), bits of write strobe signal (WSTRB), and information relating to whether the burst is the last burst (END OF BURST). The payload includes write data.

FIG. 13D illustrates a structure of a write response packet transmitted through the write response channel 150 in FIG. 3.

Referring to FIG. 13D, the write response packet has only a header. The header includes information of a packet type (Type), identification of a slave device which has responded (BID), and information relating to whether the slave device has accepted the request (BRESP).

In description with reference to the FIGS. 13A to 13D, the packets may correspond to the transactions in FIGS. 6 and 7. In addition, the packet headers may correspond to the first sub-transactions in FIGS. 6 and 7, and the payloads may correspond to the remaining sub-transactions in FIGS. 6 and 7.

As described above, according to example embodiments, the interface device and the system may split the transaction according to the size of address included the transaction. In addition, the interface device and the system may merge the split transactions. Therefore, it is possible to decrease latency and system overhead resulting from the size of the transaction.

The interface device and the system according to example embodiments can be applied to system on chip (SoC).

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of inventive concepts. Accordingly, all such modifications are intended to be included within the scope of inventive concepts as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An interface device comprising:
a transaction management unit configured to selectively split a transaction from a master device into a first sub-transaction and at least one remaining sub-transaction based on a size of the transaction;
a buffer unit configured to store the at least one remaining sub-transaction; and
a selection circuit configured to select one of the first sub-transaction and an output of the buffer unit in response to a select control signal.

2. The interface device of claim 1, further comprising:
a boundary check unit configured to receive the transaction and generate a check signal to the transaction management unit, the check signal indicating if the size of the transaction exceeds a reference value.

3. The interface device of claim 2, wherein if the size of the transaction exceeds the reference value, the boundary check unit is configured to generate the check signal having a first logic level and the transaction management unit is configured to split the transaction into the first sub-transaction and the at least one remaining sub-transaction.

4. The interface device of claim 3, wherein if the size of the transaction is below the reference value, the boundary check unit is configured to generate the check signal having a second logic level and the transaction management unit is configured to provide the transaction to the selection circuit without splitting.

5. The interface device of claim 1, wherein the size of the transaction corresponds to a size of an address in the transaction.

6. The interface device of claim 1, wherein the buffer unit comprises:
a plurality of registers configured to store the at least one remaining sub-transaction, and
the buffer unit is configured to sequentially output the at least one remaining sub-transaction to the selection circuit.

7. The interface device of claim 1, further comprising:
a merging unit configured to merge the at least one remaining sub-transaction provided sequentially from the buffer unit and generate a merged sub-transaction to the selection circuit.

8. The interface device of claim 1, wherein the transaction is one of a write transaction and a read transaction.

9. The interface device of claim 1, wherein the interface device is configured to operate according to Advanced Extensible Interface (AXI) protocol.

10. A system comprising:
a plurality of master devices;
a plurality of slave devices;
an interconnect device configured to connect the plurality of master devices and the plurality of slave devices; and
a slave interface device between each of the plurality of slave devices and the interconnect device, the slave interface device configured to process data that is transmitted between at least one of the plurality of master devices and one of the plurality of slave devices associated with the slave interface device,
wherein the slave interface device includes,
a transaction management unit configured to selectively split a transaction from one of the plurality of master devices into a first sub-transaction and at least one remaining sub-transaction based on a size of the transaction,
a buffer unit configured to store the at least one remaining sub-transaction, and
a selection circuit configured to select one of the first sub-transaction and an output of the buffer unit in response to a select control signal provided from one of the plurality of slave devices.

11. The system of claim 10, wherein the plurality of master devices and the plurality of slave devices are on one chip.

12. The system of claim 10, wherein the interconnect device comprises:
an arbiter configured to generate an arbitration signal based on a transaction from each of the plurality of master devices; and
a routing unit configured to select one of the transactions based on the arbitration signal.

13. The system of claim 10, further comprising:
a master interface device between each of the plurality of master devices and the interconnect device, the master interface device configured to process data transmitted between at least one of the plurality of slave devices and one of the plurality of master devices associated with the master interface device.

14. The system of claim 13, wherein the master interface device comprises:
an arbiter configured to generate an arbitration signal;
a buffer configured to receive packets from the at least one of the plurality of slave devices; and
a selection circuit configured to select one of the packets stored in the buffer to provide to the corresponding master device based on the arbitration signal.

15. The system of claim 10, wherein each of the plurality of slave devices is a memory device.

16. A system configured to perform a transaction comprising:
at least one master device configured to transmit a transaction, the transaction identifying an address of an at least one slave device to receive the transaction;
a slave interface device associated with the at least one slave device, the slave interface device configured to receive the transaction and divide the transaction into a plurality of sub-transactions based on a size of the address; and
the at least one slave device configured to receive the plurality of sub-transactions.

17. The system of claim 16, wherein the slave interface device includes, a transaction management unit configured to divide the transaction into a first sub-transaction and a plurality of remaining sub-transactions.

18. The system of claim 17, wherein the slave interface device includes,
a selection circuit configured to select one of the first sub-transaction and the plurality of remaining sub-transactions to send to the at least one slave device based on a select control signal.

19. The system of claim 17, wherein the slave interface device includes,
a merging unit configured to merge the plurality of remaining sub-transactions to generate a merged sub-transaction.

20. The system of claim 19, wherein the slave interface device includes,
a selection circuit configured to select one of the first sub-transaction and the merged sub-transaction to send to the at least one slave device based on a select control signal.
